(19) United States
(12) Patent Application Publication
(10) Pub. No.: US 2021/0383965 A1
(43) Pub. Date: Dec. 9, 2021

(54) IGNITION SYSTEM

(71) Applicant: Mitsubishi Electric Corporation, Tokyo (JP)

(72) Inventors: Naoki KATAOKA, Tokyo (JP); Yuichi MURAMOTO, Tokyo (JP)

(73) Assignee: Mitsubishi Electric Corporation, Tokyo (JP)

(21) Appl. No.: 17/288,126

(22) PCT Filed: Dec. 7, 2018
(86) PCT No.: PCT/JP2018/045105

§ 371 Date: Apr. 23, 2021

(51) Int. Cl. H01F 38/12

(52) U.S. Cl. CPC H01F 38/12; F02P 3/05

(57) ABSTRACT

Provided is an ignition system including: a main primary coil; a sub primary coil; a secondary coil; a control unit configured to: drive a main IC to switch a main primary coil mode from a de-energization mode to an energization mode; stop the drive of the main IC to switch the main primary coil mode from the energization mode to the de-energization mode; drive the sub IC to switch a sub primary coil mode from a de-energization mode to an energization mode; and stop the drive of the sub IC to switch the sub primary coil mode from the energization mode to the de-energization mode; and a detection circuit configured to detect a state of the secondary coil. The ignition system is configured such that the drive of the sub IC is stopped when the state of the secondary coil detected by the detection circuit is a no-current supply state.

### TECHNICAL FIELD

The present invention relates to an ignition system.

### BACKGROUND ART

Hitherto, as an ignition system configured to ignite an air-fuel mixture in a combustion chamber of an internal combustion engine, there has been proposed an ignition system including an ignition coil formed of a main primary coil, a sub primary coil, and a secondary coil (for example, see Patent Literature 1).

The ignition system described in Patent Literature 1 is configured to superimpose, in an adding manner, a current generated in the secondary coil by interrupting current supply from a power supply to the main primary coil and a current generated in the secondary coil as a result of current supply from the power supply to the sub primary coil on each other, to thereby obtain a current, and to cause the obtained current to flow through the secondary coil.

### CITATION LIST

### Patent Literature

[PTL 1] U.S. Pat. No. 9,399,979 B2

### SUMMARY OF INVENTION

### Technical Problem

In the ignition system described in Patent Literature 1, when control of supplying a secondary current to the secondary coil is executed, there may occur a case in which a sub primary current continues to flow through the sub primary coil even when the secondary current has disappeared. In this case, a potential difference across the sub primary coil becomes larger, and an excessive current may be generated. This current increases heat generation of the sub primary coil, and the ignition coil may consequently be damaged.

The present invention has been made to solve the above-mentioned problem, and has an object to provide an ignition system capable of suppressing occurrence of a case in which a sub primary current continues to flow through a sub primary coil even when a secondary current flowing through a secondary coil has disappeared.

### Solution to Problem

According to one embodiment of the present invention, there is provided an ignition system including: a main primary coil configured to generate an energization magnetic flux through current supply, and to generate a de-energization magnetic flux in an opposite direction to a direction of the energization magnetic flux through interruption of the current supply; a main IC configured to switch a main primary coil mode which is a mode of the main primary coil between an energization mode for supplying a current to the main primary coil and a de-energization mode for interrupting the supply of the current to the main primary coil; a sub primary coil configured to generate an additional magnetic flux in the same direction as the direction of the de-energization magnetic flux through current supply; a sub IC configured to switch a sub primary coil mode which is a mode of the sub primary coil between an energization mode for supplying a current to the sub primary coil and a de-energization mode for interrupting the supply of the current to the sub primary coil; a secondary coil configured to magnetically couple to the main primary coil and the sub primary coil, to thereby generate energy; a control unit configured to drive the main IC to switch the main primary coil mode from the de-energization mode to the energization mode, stop the drive of the main IC to switch the main primary coil mode from the energization mode to the de-energization mode, drive the sub IC to switch the sub primary coil mode from the de-energization mode to the energization mode, and to stop the drive of the sub IC to switch the sub primary coil mode from the energization mode to the de-energization mode; and a detection circuit configured to detect a state of the secondary coil, wherein the drive of the sub IC is stopped when the state of the secondary coil detected by the detection circuit is a no-current supply state.

### Advantageous Effects of Invention

According to the present invention, it is possible to provide the ignition system capable of suppressing the occurrence of the case in which the sub primary current continues to flow through the sub primary coil even when the secondary current flowing through the secondary coil has disappeared.

### BRIEF DESCRIPTION OF DRAWINGS

FIG. 1 is a configuration diagram for illustrating an ignition system according to a first embodiment of the present invention.

FIG. 2 is a timing chart for illustrating an operation example of the ignition system according to the first embodiment of the present invention.

FIG. 3 is a configuration diagram for illustrating an ignition system according to a second embodiment of the present invention.

FIG. 4 is a timing chart for illustrating an operation example of the ignition system according to the second embodiment of the present invention.

FIG. 5 is a configuration diagram for illustrating an ignition system according to a third embodiment of the present invention.

FIG. 6 is a configuration diagram for illustrating an ignition system according to a fourth embodiment of the present invention.

FIG. 7 is a configuration diagram for illustrating an ignition system according to a fifth embodiment of the present invention.

FIG. 8 is a timing chart for illustrating an operation example of the ignition system according to the fifth embodiment of the present invention.

FIG. 9 is a configuration diagram for illustrating an ignition system according to a sixth embodiment of the present invention.

FIG. 10 is a timing chart for illustrating an operation example of the ignition system according to the sixth embodiment of the present invention.

FIG. 11 is a configuration diagram for illustrating an ignition system in a comparative example.

FIG. 12 is a timing chart for illustrating an operation example of the ignition system in the comparative example.

### DESCRIPTION OF EMBODIMENTS

Now, an ignition system according to preferred embodiments of the present invention is described referring to the accompanying drawings. In the illustration of the drawings, the same or corresponding components are denoted by the same reference symbols, and overlapping description thereof is herein omitted.

### First Embodiment

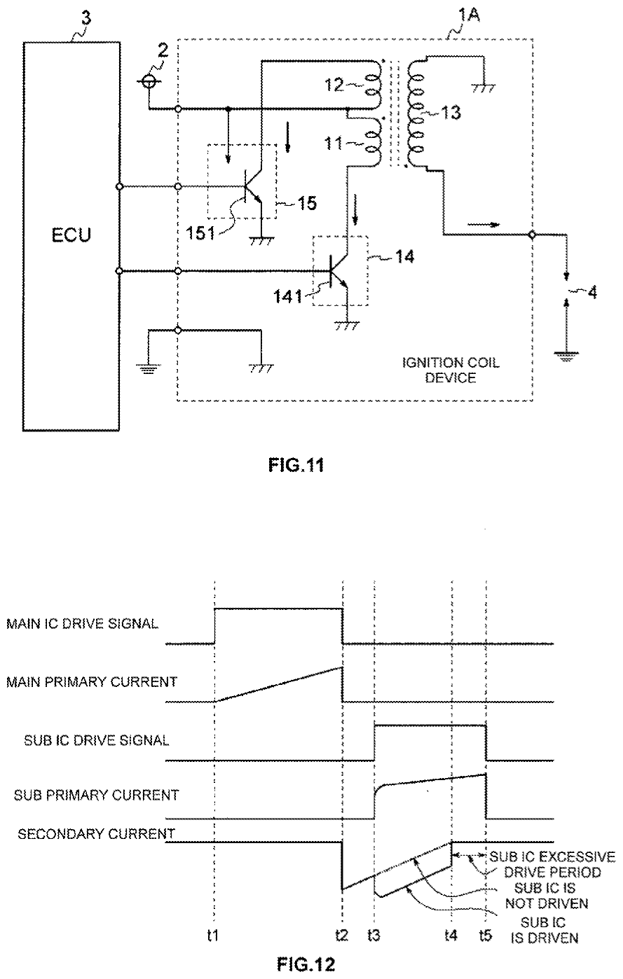

Description is now given of an ignition system in a comparative example as an example to be compared with an ignition system according to a first embodiment of the present invention. FIG. 11 is a configuration diagram for illustrating the ignition system in the comparative example. The ignition system illustrated in FIG. 11 includes an ignition coil device 1A, a power supply 2, an engine control unit (ECU) 3, and an ignition plug 4.

The ignition coil device 1A is mounted to an internal combustion engine, and is configured to supply energy to the ignition plug 4, to thereby generate a spark discharge in a gap of the ignition plug 4. The ignition coil device 1A includes a main primary coil 11, a sub primary coil 12, a secondary coil 13, a main integrated circuit (IC) 14, and a sub integrated circuit (IC) 15.

Each of the main primary coil 11 and the sub primary coil 12 is connected to the common power supply 2. The power supply 2 is a DC power supply, for example, a battery.

The main primary coil 11 and the sub primary coil 12 are wound so that respective magnetic fluxes generated when currents are supplied from the power supply 2 are in directions opposite to each other. That is, as seen from the power supply 2, respective polarities of the main primary coil 11 and the sub primary coil 12 are polarities opposite to each other.

When the current is supplied to the main primary coil 11 from the power supply 2, the polarity of the main primary coil 11 is an opposite polarity to the polarity of the secondary coil 13. When the current is supplied to the sub primary coil 12 from the power supply 2, the polarity of the sub primary coil 12 is the same polarity as the polarity of the secondary coil 13.

The main primary coil 11 and the sub primary coil 12 are magnetically coupled to the secondary coil 13. As a result, mutual induction occurs between the main primary coil 11 and the secondary coil 13, and between the sub primary coil 12 and the secondary coil 13.

The main primary coil 11 is configured to generate a magnetic flux through the current supply from the power supply 2. The magnetic flux generated by the main primary coil 11 through the current supply from the power supply 2 is hereinafter referred to as “energization magnetic flux.” Moreover, the main primary coil 11 is configured to generate a magnetic flux in an opposite direction to a direction of the energization magnetic flux through interruption of the current supply from the power supply 2. The magnetic flux generated by the main primary coil 11 through the interruption of the current supply from the power supply 2 is hereinafter referred to as “de-energization magnetic flux.”

The sub primary coil 12 is configured to generate a magnetic flux in the same direction as the direction of the energization magnetic flux through the current supply from the power supply 2. The magnetic flux generated by the sub primary coil 12 through the current supply from the power supply 2 is hereinafter referred to as “additional magnetic flux.”

One end of the secondary coil 13 is connected to the ignition plug 4. The other end thereof is connected to a ground. The secondary coil 13 is magnetically coupled to the main primary coil 11 and the sub primary coil 12, to thereby generate energy. The energy generated by the secondary coil 13 is supplied to the ignition plug 4.

When the energy is supplied to the ignition plug 4, the spark discharge is generated in the gap of the ignition plug 4. As a result, the ignition plug 4 ignites a combustible air-fuel mixture in a combustion chamber of the internal combustion engine, to thereby combust the combustible air-fuel mixture.

The main IC 14 is configured to switch a mode of the main primary coil 11 between an energization mode of supplying the current from the power supply 2 to the main primary coil 11 and a de-energization mode of interrupting the current supply from the power supply 2 to the main primary coil 11. The mode of the main primary coil 11 is hereinafter referred to as “main primary coil mode.”

Specifically, the main IC 14 is formed of a transistor 141 switchable between ON and OFF states. A collector of the transistor 141 is connected to the main primary coil 11. An emitter of the transistor 141 is connected to the ground.

When the transistor 141 is in the ON state, the transistor 141 conducts a current between the power supply 2 and the main primary coil 11. As a result, the current supply from the power supply 2 to the main primary coil 11 can be achieved. Meanwhile, when the transistor 141 is in the OFF state, the transistor 141 interrupts the conduction between the power supply 2 and the main primary coil 11. As a result, the interruption of the current supply from the power supply 2 to the main primary coil 11 can be achieved.

The sub IC 15 is configured to switch a mode of the sub primary coil 12 between an energization mode of supplying the current from the power supply 2 to the sub primary coil 12 and an de-energization mode of interrupting the current supply from the power supply 2 to the sub primary coil 12. The mode of the sub primary coil 12 is hereinafter referred to as “sub primary coil mode.”

Specifically, the sub IC 15 is formed of a transistor 151 switchable between ON and OFF states. A collector of the transistor 151 is connected to the sub primary coil 12. An emitter of the transistor 151 is connected to the ground.

When the transistor 151 is in the ON state, the transistor 151 conducts a current between the power supply 2 and the sub primary coil 12. As a result, the current supply from the power supply 2 to the sub primary coil 12 can be achieved. Meanwhile, when the transistor 151 is in the OFF state, the transistor 151 interrupts the conduction between the power supply 2 and the sub primary coil 12. As a result, the interruption of the current supply from the power supply 2 to the sub primary coil 12 can be achieved.

The ECU 3 is an example of a control unit configured to control the ignition coil device 1A. The ECU 3 is configured to acquire detection results of various sensors configured to detect information on an operation state of the internal combustion engine, and determine the operation state of the internal combustion engine based on the acquired detection results of the various sensors, to thereby control the ignition coil device 1A. Specifically, the ECU 3 controls drive of each of the main IC 14 and the sub IC 15 of the ignition coil device 1A.

For the convenience of description, a direction of a flow of the current from the main primary coil 11 toward the main IC 14, that is, a direction of the arrow illustrated in FIG. 11, is hereinafter defined as a positive direction. A direction of a flow of the current from the main IC 14 toward the main primary coil 11 is defined as a negative direction. Further, a direction of a flow of the current from the sub primary coil 12 toward the sub IC 15, that is, a direction of the arrow illustrated in FIG. 11, is defined as a positive direction. A direction of a flow of the current from the sub IC 15 toward the sub primary coil 12 is defined as a negative direction.

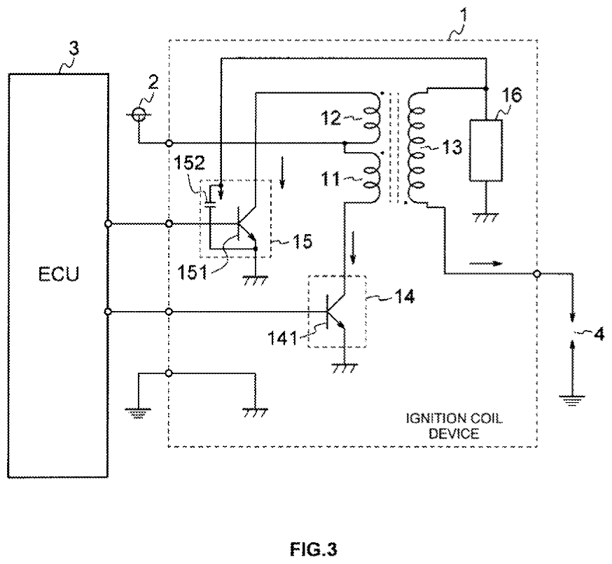

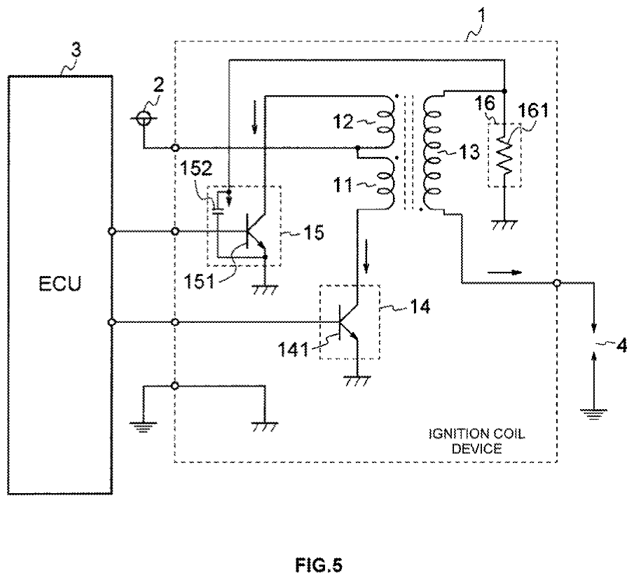

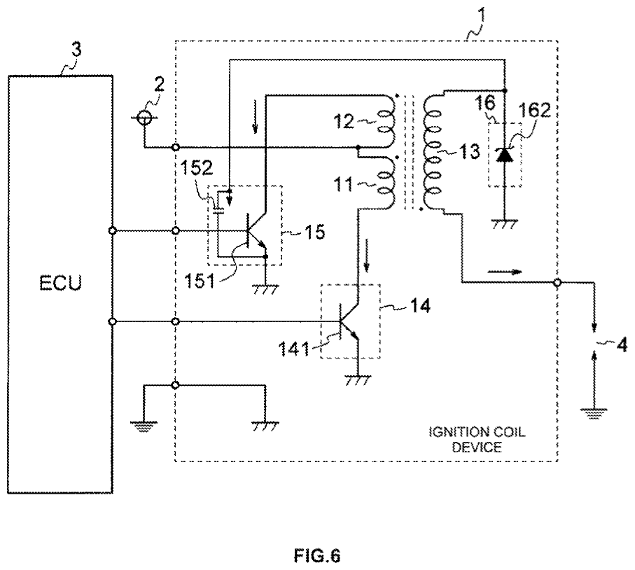

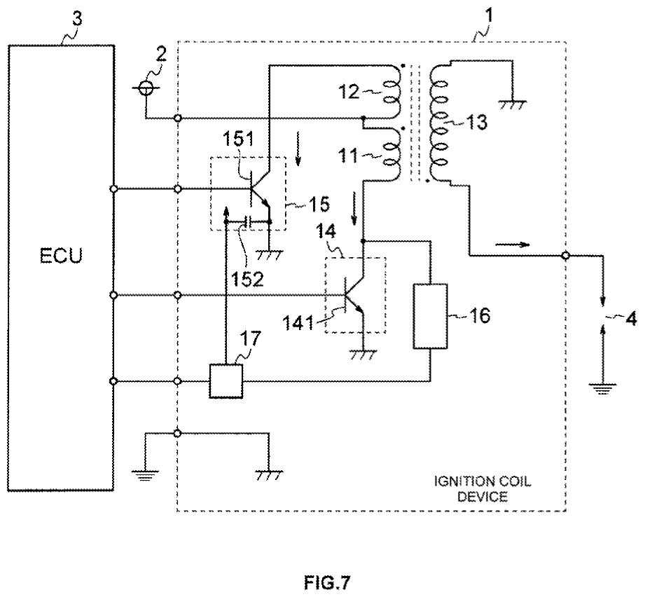

In addition, a direction of a flow of the current from the secondary coil 13 toward the ignition plug 4, that is, a direction of the arrow illustrated FIG. 11, is defined as a positive direction. A direction of a flow of the current from the ignition plug 4 toward the secondary coil 13 is defined as a negative direction. Those definitions are the same as those for FIG. 1, FIG. 3, FIG. 5, FIG. 6, and FIG. 7, which are described below.

With reference to FIG. 12, description is given of an operation example of the ignition system in the comparative example. FIG. 12 is a timing chart for illustrating the operation example of the ignition system in the comparative example. In FIG. 12, respective temporal changes in a main IC drive signal, a main primary current, a sub IC drive signal, a sub primary current, and a secondary current are illustrated.

Of those, the main IC drive signal is a signal for driving the main IC 14. When the main IC drive signal is input from the ECU 3 to the main IC 14, the main primary coil mode is switched from the de-energization mode to the energization mode by the drive by the main IC 14. The main primary current is a current flowing through the main primary coil 11.

The sub IC drive signal is a signal for driving the sub IC 15. When the sub IC drive signal is input from the ECU 3 to the sub IC 15, the sub primary coil mode is switched from the de-energization mode to the energization mode by the drive by the sub IC 15. The sub primary current is a current flowing through the sub primary coil 12. The secondary current is a current flowing through the secondary coil 13.

As illustrated in FIG. 12, when the input of the main IC drive signal from the ECU 3 to the main IC 14 is started at a time t1, the drive of the main IC 14 is started. In this case, the main primary coil mode is switched to the energization mode, and the main primary current in the positive direction thus flows through the main primary coil 11.

At a time t2, when the input of the main IC drive signal from the ECU 3 to the main IC 14 is stopped, the drive of the main IC 14 is stopped. In this case, the main primary coil mode is switched to the de-energization mode, and the main primary current thus becomes 0.

When the main primary coil mode is switched to the de-energization mode, a voltage is generated in the secondary coil 13 by the mutual induction effect. A dielectric breakdown occurs in the gap of the ignition plug 4 due to the generated voltage, to thereby generate a discharge, and the secondary current in the negative direction thus flows through the secondary coil 13.

At a time t3, when the input of the sub IC drive signal from the ECU 3 to the sub IC 15 is started, the drive of the sub IC 15 is started. In :his case, the sub primary coil mode is switched to the energization mode, and the sub primary current flows through the sub primary coil 12. As illustrated in FIG. 12, the sub primary current quickly rises, and slowly increases after the rise.

As a result of the flow of the sub primary current through the sub primary coil 12, a superimposition current is generated in the secondary coil 13. The superimposition current is generated in the secondary coil 13 in accordance with a turn ratio between the sub primary coil 12 and the secondary coil 13. As illustrated in FIG. 12, the superimposition current induced by the sub primary coil 12 is superimposed on the secondary current induced by the main primary coil 11.

At a time t4, the drive of the sub IC 15 is continuing, and the sub primary current is thus flowing through the sub primary coil 12, but the secondary current flowing through the secondary coil 13 becomes 0. That is, the secondary current flowing through the secondary coil 13 disappears.

At a time t5, when the input of the sub IC drive signal from the ECU 3 to the sub IC 15 is stopped, the drive of the sub IC 15 is stopped. That is, the ECU 3 stops the drive of the sub IC 15, to thereby switch the sub primary coil mode from the energization mode to the de-energization mode. In this case, the sub primary coil mode is switched to the de-energization mode, and the sub primary current thus becomes 0.

A period between the time t4 and the time t5, that is, a sub IC excessive drive period, is now focused on. In this period, the secondary current has disappeared, but the sub primary current continues to flow through the sub primary coil 12. In this case, as described above, a potential difference across the sub primary coil 12 increases, and an excessive current is thus generated.

Heat generation of the sub primary coil 12 and the sub IC 15 is increased by this current, and the ignition coil device 1 may consequently be damaged. Moreover, after the secondary current flowing through the secondary coil 13 has disappeared, when the transistor 151 is switched from ON to OFF in order to stop the drive of the sub IC 15, a voltage in the opposite polarity is generated in the secondary coil 13. As a result, various types of elements incorporated in the ignition coil device 1 may be damaged.

As can be understood from the description given above, the configuration of the ignition system in the comparative example is such a configuration that the sub primary current continues to flow through the sub primary coil 12 even when the secondary current has disappeared, and the above-mentioned problem may thus occur. Meanwhile, the ignition system according to the first embodiment is configured to interrupt the flow of the sub primary current through the sub primary coil 12 regardless of the sub IC drive signal when the secondary current has disappeared.

With reference to FIG. 1, description is now given of the ignition system according to the first embodiment of the present invention. FIG. 1 is a configuration diagram for illustrating the ignition system according to the first embodiment of the present invention. In the description of the ignition system according to the first embodiment, the same points as those of the ignition system in the above-mentioned comparative example are omitted, and description is mainly given of points different from those of the ignition system in the comparative example.

The ignition system illustrated in FIG. 1 includes an ignition coil device 1, the power supply 2, the ECU 3, and the ignition plug 4. The ignition coil device 1 is mounted to the internal combustion engine, and is configured to supply the energy to the ignition plug 4, to thereby generate the spark discharge in the gap of the ignition plug 4. The ignition coil device 1 includes the main primary coil 11, the sub primary coil 12, the secondary coil 13, the main IC 14, the sub IC 15, a detection circuit 16, and a sub IC drive determination circuit 17.

The detection circuit 16 is connected to the secondary coil 13, to thereby detect a state of the secondary coil 13. Specifically, the detection circuit 16 detects the secondary current flowing through the secondary coil 13 as the state of the secondary coil 13, and outputs a result of the detection to the sub IC drive determination circuit 17.

The sub IC drive determination circuit 17 is configured to execute control of stopping the drive of the sub IC 15 when the state of the secondary coil 13 detected by the detection circuit 16 is the state in which the secondary current is not flowing through the secondary coil 13, that is, a no-current supply state.

Specifically, the sub IC drive determination circuit 17 executes the control of stopping the drive of the sub IC 15 based on the secondary current detected by the detection circuit 16 as the state of the secondary coil 13.

More specifically, the sub IC drive determination circuit 17 executes the control of stopping the drive of the sub IC 15 when a magnitude of the secondary current detected by the detection circuit 16 is equal to or smaller than a current threshold value set in advance. In this configuration, the current threshold value is, for example, 0. Moreover, the current threshold value may be a value obtained by appropriately adding a margin to 0 which serves as a reference. As described above, the sub IC drive determination circuit 17 stops the drive of the sub IC 15 when the magnitude of the secondary current detected by the detection circuit 16 becomes equal to or smaller than the current threshold value. Thus, it is possible to control the sub IC 15 from the sub IC drive determination circuit 17 side regardless of the control from the ECU 3 side only during a period in which the secondary current is supplied to the secondary coil 13.

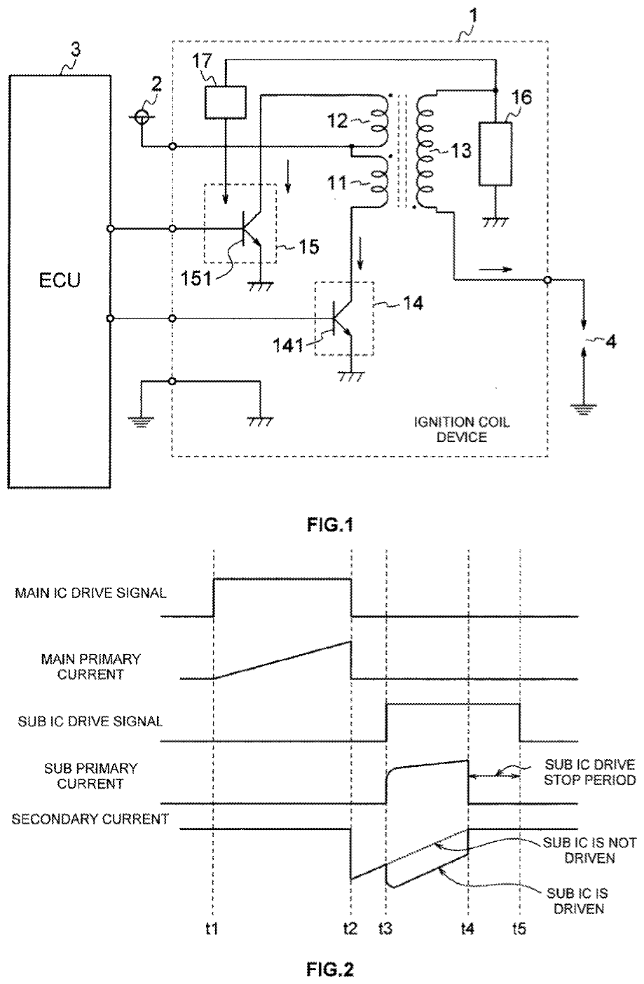

With reference to FIG. 2, description is now given of an operation example of the ignition system according to the first embodiment. FIG. 2 is a timing chart for illustrating the operation example of the ignition system according to the first embodiment of the present invention. In FIG. 2, respective temporal changes in the main IC drive signal, the main primary current, the sub IC drive signal, the sub primary current, and the secondary current are illustrated.

As illustrated in FIG. 2, when the input of the main IC drive signal from the ECU 3 to the main IC 14 is started at the time t1, the drive of the main IC 14 is started. In this case, the main primary coil mode is switched to the energization mode, and the main primary current in the positive direction thus flows through the main primary coil 11.

As described above, at the time t1, the ECU 3 drives the main IC 14, to thereby switch the main primary coil mode from the de-energization mode to the energization mode.

At the time t2, when the input of the main IC drive signal from the ECU 3 to the main IC 14 is stopped, the drive of the main IC 14 is stopped. In this case, the main primary coil mode is switched to the de-energization mode, and the main primary current becomes 0.

When the main primary coil mode is switched to the de-energization mode, the voltage is generated in the secondary coil 13 by the mutual induction effect. The dielectric breakdown occurs in the gap of the ignition plug 4 due to the generated voltage, to thereby generate the discharge, and the secondary current in the negative direction flows through the secondary coil 13.

As described above, at the time t2, the ECU 3 stops the drive of the main IC 14, to thereby switch the main primary coil mode from the energization mode to the de-energization mode.

At the time t3, when the input of the sub IC drive signal from the ECU 3 to the sub IC 15 is started, the drive of the sub IC 15 is started. In :his case, the sub primary coil mode is switched to the energization mode, and the sub primary current flows through the sub primary coil 12. As illustrated in FIG. 2, the sub primary current quickly rises, and slowly increases after the rise.

As a result of the flow of the sub primary current through the sub primary coil 12, the superimposition current is generated in the secondary coil 13. The superimposition current is generated in the secondary coil 13 in accordance with the turn ratio between the sub primary coil 12 and the secondary coil 13. As illustrated in FIG. 2, the superimposition current induced by the sub primary coil 12 is superimposed on the secondary current induced by the main primary coil 11.

As described above, at the time t3, the ECU 3 drives the sub IC 15, to thereby switch the sub primary coil mode from the de-energization mode to the energization mode.

At the time t4, the input of the sub IC drive signal from the ECU 3 to the sub IC 15 is continuing. However, the secondary current detected by the detection circuit 16 is 0, and the sub IC drive determination circuit 17 thus stops the drive of the sub IC 15. That is, when the secondary current flowing through the secondary coil 13 disappears, the sub IC drive determination circuit 17 stops the drive of the sub IC 15 regardless of the sub IC drive signal.

As a result, when the secondary current flowing through the secondary coil 13 has disappeared, the drive of the sub IC 15 can be stopped from the sub IC drive determination circuit 17 side regardless of the control of the sub IC 15 from the ECU 3 side.

At the time t5, the input of the sub IC drive signal from the ECU 3 to the sub IC 15 is stopped. The period between the time t4 and the time t5, that is, a sub IC drive stop period, is now focused on. In this period, the flow of the sub primary current to the sub primary coil 12 is interrupted in accordance with the disappearance of the secondary current flowing through the secondary coil 13 regardless of the sub IC drive signal, which is different from the sub IC excessive drive period illustrated in FIG. 12.

Thus, in the ignition system according to the first embodiment, it is possible to suppress the continuing flow of the sub primary current to the sub primary coil 12 even when the secondary current has disappeared, which is different from the ignition system in the comparative example.

As described above, in the first embodiment, the ignition system is configured such that the drive of the sub IC 15 is stopped when the state of the secondary coil 13 detected by the detection circuit 16 is the no-current supply state. In the first embodiment, there is exemplified the case in which the sub IC drive determination circuit 17 is configured to stop the drive of the sub IC 15 based on the secondary current detected by the detection circuit 16 as the state of the secondary coil 13.

As a result, the sub IC 15 can be controlled regardless of the control by the ECU 3 side, and it is possible to suppress the occurrence of the case in which the sub primary current continues to flow to the sub primary coil 12 even when the secondary current flowing through the secondary coil 13 has disappeared.

It is thus possible to suppress the increase in heat generation of the sub primary coil 12 and the sub IC 15 which is caused by the generation of the excessive current due to the increase in potential difference across the sub primary coil 12, to thereby consequently suppress the damage to the ignition coil device 1. Moreover, it is possible to suppress the generation of the voltage having the opposite polarity in the secondary coil 13, to thereby consequently suppress the damage to the various types of elements incorporated in the ignition coil device 1.

### Second Embodiment

In a second embodiment of the present invention, description is given of an ignition system including the ignition coil device 1 having a different configuration from that in the first embodiment. Note that, in the second embodiment, the description of the same points as those of the first embodiment is omitted, and points different from those of the first embodiment are mainly described.

FIG. 3 is a configuration diagram for illustrating the ignition system according to the second embodiment of the present invention. The ignition system illustrated in FIG. 3 includes the ignition coil device 1, the power supply 2, the ECU 3, and the ignition plug 4. The ignition coil device 1 includes the main primary coil 11, the sub primary coil 12, the secondary coil 13, the main IC 14, the sub IC 15, and the detection circuit 16.

The detection circuit 16 is connected to the secondary coil 13, and is configured to generate a voltage in accordance with the flow of the secondary current through the secondary coil 13 when the main primary coil mode is switched from the energization mode to the de-energization mode.

The detection circuit 16 is configured to supply, to the sub IC 15, the generated voltage as a sub IC power supply voltage, which is a voltage for driving the sub IC 15. That is, while the secondary current is flowing through the secondary coil 13, the voltage generated by the detection circuit 16 in accordance with the secondary current is used as the sub IC power supply voltage. As a result, when the secondary current is flowing through the secondary coil 13, there is brought about the state in which the sub IC 15 can be driven. When the secondary current disappears, there is brought about the state in which the sub IC 15 cannot be driven.

As described above, the detection circuit 16 is configured to generate the voltage as the state of the secondary coil 13 in accordance with the flow of the secondary current through the secondary coil 13, and to supply the generated voltage to the sub IC 15 as the sub IC power supply voltage for driving the sub IC 15.

The sub IC 15 includes the transistor 151 and a capacitor 152. The capacitor 152 serves to suppress a surge voltage entering the sub IC 15 as a result of the flow of the secondary current through the secondary coil 13 when the main primary coil mode is switched from the energization mode to the de-energization mode. With this configuration, it is possible to suppress destruction of the sub IC 15. A capacitance of the capacitor 152 is, for example, equal to or lower than 0.72 μF.

It is possible to suppress, by providing the capacitor 152 in the sub IC 15 as described above, the surge voltage generated at the timing at which the current supply from the power supply 2 to the main primary coil 11 is interrupted. As a result, the destruction of the sub IC 15 can be suppressed. Moreover, the capacitor 152 can be used together with a capacitor usually provided in the ignition coil device 1 by setting the capacitance of the capacitor 152 to a value equal to or lower than 0.72 μF.

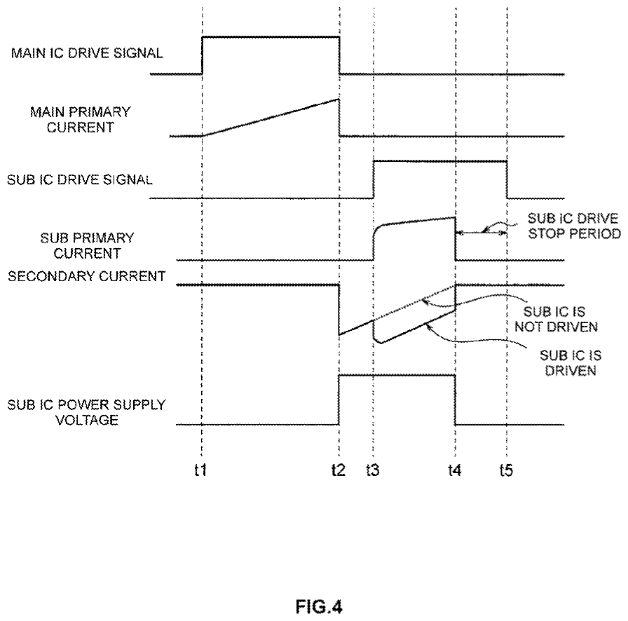

With reference to FIG. 4, description is now given of an operation example of the ignition system according to the second embodiment. FIG. 4 is a timing chart for illustrating the operation example of the ignition system according to the second embodiment of the present invention. In FIG. 4, respective temporal changes in the main IC drive signal, the main primary current, the sub IC drive signal, the sub primary current, the secondary current, and the sub IC power supply voltage are illustrated.

The sub IC power supply voltage is a power supply voltage for driving the sub IC 15. As described above, the detection circuit 16 generates the voltage in accordance with the flow of the secondary current through the secondary coil 13, and supplies the generated voltage to the sub IC 15 as the sub IC power supply voltage.

As illustrated in FIG. 4, when the input of the main IC drive signal from the ECU 3 to the main IC 14 is started at the time t1, the drive of the main IC 14 is started. In this case, the main primary coil mode is switched to the energization mode, and the main primary current in the positive direction thus flows through the main primary coil 11.

At the time t2, when the input of the main IC drive signal from the ECU 3 to the main IC 14 is stopped, the drive of the main IC 14 is stopped. In this case, the main primary coil mode is switched to the de-energization mode, and the main primary current becomes 0.

When the main primary coil mode is switched to the de-energization mode, the voltage is generated in the secondary coil 13 by the mutual induction effect. The dielectric breakdown occurs in the gap of the ignition plug 4 due to the generated voltage, to thereby generate the discharge, and the secondary current in the negative direction flows through the secondary coil 13.

At the time t2, the detection circuit 16 generates the voltage in accordance with the flow of the secondary current through the secondary coil 13, and supplies the generated voltage to the sub IC 15 as the sub IC power supply voltage. Thus, as illustrated in FIG. 4, the supply of the sub IC power supply voltage to the sub IC 15 is started at the time t2, and there is thus brought about the state in which the sub IC 15 can be driven.

At the time t3, when the input of the sub IC drive signal from the ECU 3 to the sub IC 15 is started, the drive of the sub IC 15 which can be driven is started. In this case, similarly to the operation illustrated in FIG. 2, the sub primary coil mode is switched to the energization mode, and the sub primary current flows through the sub primary coil 12.

As a result of the flow of the sub primary current through the sub primary coil 12, the superimposition current is generated in the secondary coil 13. The superimposition current is generated in the secondary coil 13 in accordance with the turn ratio between the sub primary coil 12 and the secondary coil 13. As illustrated in FIG. 4, the superimposition current induced by the sub primary coil 12 is superimposed on the secondary current induced by the main primary coil 11.

At the time t4, the input of the sub IC drive signal from the ECU 3 to the sub IC 15 is continuing. However, the secondary current flowing through the secondary coil 13 becomes 0 at the time t4, and the voltage generated by the detection circuit 16 thus becomes 0. Thus, as illustrated in FIG. 4, the sub IC power supply voltage becomes 0, and the supply of the sub IC power supply voltage from the detection circuit 16 to the sub IC 15 is stopped. Therefore, the drive of the sub IC 15 is stopped regardless of the sub IC drive signal input from the ECU 3. That is, when the secondary current flowing through the secondary coil 13 disappears, the supply of the sub IC power supply voltage from the detection circuit 16 to the sub IC 15 is stopped, and the drive of the sub IC 15 is thus stopped regardless of the sub IC drive signal.

As a result, even in the case in which the input of the sub IC drive signal from the ECU 3 to the sub IC 15 is continuing, when the secondary current disappears, the drive of the sub IC 15 can be stopped.

At the time t5, the input of the sub IC drive signal from the ECU 3 to the sub IC 15 is stopped. The period between the time t4 and the time t5, that is, the sub IC drive stop period, is now focused on. In this period, the flow of the sub primary current to the sub primary coil 12 is interrupted in accordance with the disappearance of the secondary current flowing through the secondary coil 13 regardless of the sub IC drive signal, which is different from the sub IC excessive drive period illustrated in FIG. 12.

Thus, in the ignition system according to the second embodiment, it is possible to suppress the continuing flow of the sub primary current to the sub primary coil 12 even when the secondary current has disappeared, which is different from the ignition system in the comparative example.

As described above, according to the second embodiment, the detection circuit 16 in the ignition system is configured to generate the voltage as the state of the secondary coil 13 in accordance with the flow of the secondary current through the secondary coil 13, and to supply the generated voltage to the sub IC 15 as the sub IC power supply voltage for driving the sub IC 15, which is different from the first embodiment.

As a result, during the period in which the secondary current is supplied to the secondary coil 13, the sub IC 15 can be controlled through the sub IC power supply voltage regardless of the control by the ECU 3 side, and it is possible to suppress the occurrence of the case in which the sub primary current continues to flow to the sub primary coil 12 even when the secondary current flowing through the secondary coil 13 has disappeared.

### Third Embodiment

In a third embodiment of the present invention, description is given of a specific configuration example of the detection circuit 16 in the second embodiment. Note that, in the third embodiment, the description of the same points as those of the second embodiment is omitted, and points different from those of the second embodiment are mainly described.

FIG. 5 is a configuration diagram for illustrating an ignition system according to the third embodiment of the present invention. The ignition system illustrated in FIG. 5 includes the ignition coil device 1, the power supply 2, the ECU 3, and the ignition plug 4. The ignition coil device 1 includes the main primary coil 11, the sub primary coil 12, the secondary coil 13, the main IC 14, the sub IC 15, and the detection circuit 16.

The detection circuit 16 includes a resistor 161 connected to the secondary coil 13. The resistor 161 is configured to generate a voltage in accordance with the flow of the secondary current through the secondary coil 13 when the main primary coil mode is switched from the energization mode to the de-energization mode. That is, the voltage is generated in the resistor 161 by the flow of the secondary current through the resistor 161. A resistance value of the resistor 161 may be a fixed value or a variable value that changes in accordance with the value of the secondary current.

Description is now further given of the voltage generated in the resistor 161 by the flow of the secondary current through the secondary coil 13, that is, the sub IC power supply voltage supplied to the sub IC 15, while examples of specific numerical values are given.

As illustrated in FIG. 4 described above, when the main primary coil mode is switched to the de-energization mode at the time t2, a magnitude of the secondary current flowing through the secondary coil 13 is, for example, 100 mA. The magnitude of the secondary current slowly decreases from 100 mA after the time t2, and reaches 0 mA after approximately 2 ms from the time t2.

It is assumed that the resistance value of the resistor 161 is equal to or higher than 100 Ω and equal to or lower than 400 Ω. A sufficient voltage that can be used as the sub IC power supply voltage can be secured by setting the resistance value of the resistor 161 so as to be equal to or higher than 100 Ω and equal to or lower than 400 Ω.

In the above-mentioned case, the voltage generated in the resistor 161 by the flow of the secondary current through the resistor 161 at the time t2 is equal to or higher than 10 V and equal to or lower than 40 V. This voltage is used as the sub IC power supply voltage as described in the second embodiment. Thus, there is brought about the state in which the sub IC 15 can be driven only during the period in which the secondary current is flowing through the secondary coil 13. When the secondary current flowing through the secondary coil 13 becomes 0, the supply of the sub IC power supply voltage to the sub IC 15 is stopped, and the drive of the sub IC 15 can be stopped.

As described above, according to the third embodiment, as the specific configuration example of the detection circuit 16 in the second embodiment, the detection circuit 16 is formed of the resistor 161. As a result, the same effect as that of the second embodiment is provided. Moreover, the resistor 161 is used as the component of the detection circuit 16 to generate the voltage, and the voltage to be used as the sub IC power supply voltage can thus easily be generated.

### Fourth Embodiment

In a fourth embodiment of the present invention, description is given of a specific configuration example of the detection circuit 16 in the second embodiment. Note that, in the fourth embodiment, the description of the same points as those of the second embodiment is omitted, and points different from those of the second embodiment are mainly described.

FIG. 6 is a configuration diagram for illustrating an ignition system according to the fourth embodiment of the present invention. The ignition system illustrated in FIG. 6 includes the ignition coil device 1, the power supply 2, the ECU 3, and the ignition plug 4. The ignition coil device 1 includes the main primary coil 11, the sub primary coil 12, the secondary coil 13, the main IC 14, the sub IC 15, and the detection circuit 16.

The detection circuit 16 includes a Zener diode 162 connected to the secondary coil 13. The Zener diode 162 is configured to generate a voltage in accordance with the flow of the secondary current through the secondary coil 13 when the main primary coil mode is switched from the energization mode to the de-energization mode. That is, the voltage is generated in the Zener diode 162 by the flow of the secondary current through the Zener diode 162. The Zener diode 162 generates a stable voltage compared with the resistor 161 in the third embodiment.

Description is now further given of the voltage generated in the Zener diode 162 by the flow of the secondary current through the secondary coil 13, that is, the sub IC power supply voltage supplied to the sub IC 15, while examples of specific numerical values are given.

As illustrated in FIG. 4 described above, when the main primary coil mode is switched to the de-energization mode at the time t2, the magnitude of the secondary current flowing through the secondary coil 13 is, for example, 100 mA. The magnitude of the secondary current slowly decreases from 100 mA after the time t2, and reaches 0 mA after approximately 2 ms from the time t2.

It is assumed that a Zener voltage of the Zener diode 162 is equal to or higher than 5 V and equal to or lower than 20 V. A sufficient voltage that can be used as the sub IC power supply voltage can be secured by setting the Zener voltage of the Zener diode 162 so as to be equal to or higher than 5 V and equal to or lower than 20 V. It is assumed in the following that the Zener voltage of the Zener diode 162 is specifically 14 V.

In the above-mentioned case, the voltage generated by the Zener diode 162 when the secondary current flows through the Zener diode 162 at the time t2 is 14 V. This voltage is used as the sub IC power supply voltage as described in the second embodiment. Thus, there is brought about the state in which the sub IC 15 can be driven only during the period in which the secondary current is flowing through the secondary coil 13. When the secondary current flowing through the secondary coil 13 becomes 0, the supply of the sub IC power supply voltage to the sub IC 15 is stopped, and the drive of the sub IC 15 can be stopped.

As described above, according to the fourth embodiment, as the specific configuration example of the detection circuit 16 in the second embodiment, the detection circuit 16 is formed of the Zener diode 162. As a result, the same effect as that of the second embodiment is provided. Moreover, the Zener diode 162 is used as the component of the detection circuit 16 to generate the voltage, and a stable constant voltage to be used as the sub IC power supply voltage can thus easily be generated.

### Fifth Embodiment

In a fifth embodiment of the present invention, description is given of an ignition system including the ignition coil device having a different configuration from that in the first embodiment. Note that, in the fifth embodiment, the description of the same points as those of the first embodiment is omitted, and points different from those of the first embodiment are mainly described.

FIG. 7 is a configuration diagram for illustrating the ignition system according to the fifth embodiment of the present invention. The ignition system illustrated in FIG. 7 includes the ignition coil device 1, the power supply 2, the ECU 3, and the ignition plug 4. The ignition coil device 1 includes the main primary coil 11, the sub primary coil 12, the secondary coil 13, the main IC 14, the sub IC 15, the detection circuit 16, and the sub IC drive determination circuit 17.

The detection circuit 16 is connected in parallel to the transistor 141 of the main IC 14, and is configured to detect the state of the secondary coil 13. Specifically, the detection circuit 16 is configured to detect, as the state of the secondary coil 13, a main IC collector voltage that changes in accordance with the secondary current flowing through the secondary coil 13. The main IC collector voltage is a voltage generated between the collector and the emitter of the transistor 141 of the main IC 14.

The sub IC drive determination circuit 17 is configured to execute the control of stopping the drive of the sub IC 15 based on the main IC collector voltage detected by the detection circuit 16 as the state of the secondary coil 13. That is, the voltage in accordance with the secondary current flowing through the secondary coil 13 is generated between the collector and the emitter of the transistor 141. Thus, the sub IC drive determination circuit 17 detects this voltage to detect that the secondary current is not flowing through the secondary coil 13, to thereby execute control of stopping the drive of the sub IC 15.

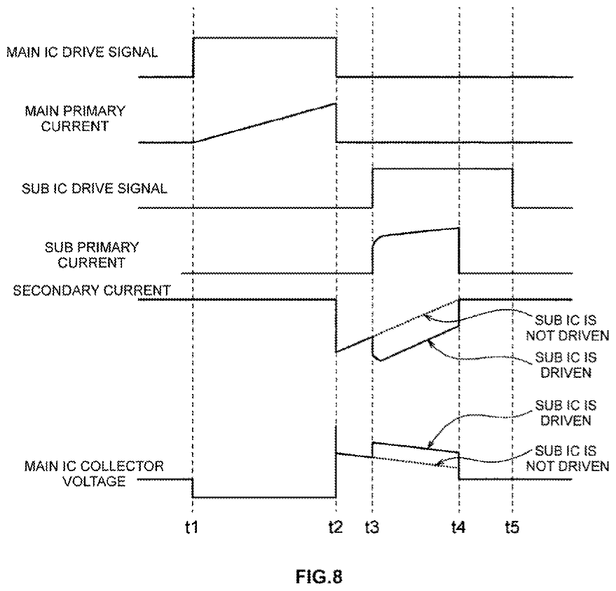

With reference to FIG. 8, description is now given of an operation example of the ignition system according to the fifth embodiment. FIG. 8 is a timing chart for illustrating the operation example of the ignition system according to the fifth embodiment of the present invention. In FIG. 8, respective temporal changes in the main IC drive signal, the main primary current, the sub IC drive signal, the sub primary current, the secondary current, and the main IC collector voltage are illustrated.

The main IC collector voltage is a voltage generated between the collector and the emitter of the transistor 141 of the main IC 14.

As illustrated in FIG. 8, when the input of the main IC drive signal from the ECU 3 to the main IC 14 is started at the time t1, the drive of the main IC 14 is started. In this case, the main primary coil mode is switched to the energization mode, and the main primary current in the positive direction thus flows through the main primary coil 11.

At the time t2, when the input of the main IC drive signal from the ECU 3 to the main IC 14 is stopped, the drive of the main IC 14 is stopped. In this case, the main primary coil mode is switched to the de-energization mode, and the main primary current becomes 0.

When the main primary coil mode is switched to the de-energization mode, the voltage is generated in the secondary coil 13 by the mutual induction effect. The dielectric breakdown occurs in the gap of the ignition plug 4 due to the generated voltage, to thereby generate the discharge, and the secondary current in the negative direction flows through the secondary coil 13.

At the time t3, when the input of the sub IC drive signal from the ECU 3 to the sub IC 15 is started, the drive of the sub IC 15 is started. In this case, similarly to the operation illustrated in FIG. 2, the sub primary coil mode is switched to the energization mode, and the sub primary current flows through the sub primary coil 12.

At the time t4, the input of the sub IC drive signal from the ECU 3 to the sub IC 15 is continuing. However, the sub IC drive determination circuit 17 detects that the secondary current is not flowing through the secondary coil 13 in accordance with the main IC collector voltage detected by the detection circuit 16, and thus stops the drive of the sub IC 15. That is, when the secondary current flowing through the secondary coil 13 disappears, the sub IC drive determination circuit 17 stops the drive of the sub IC 15 regardless of the sub IC drive signal input from the ECU 3.

As a result, when the secondary current flowing through the secondary coil 13 has disappeared, the drive of the sub IC 15 can be stopped from the sub IC drive determination circuit 17 side regardless of the control of the sub IC 15 from the ECU 3 side.

At the time t5, the input of the sub IC drive signal from the ECU 3 to the sub IC 15 is stopped. The period between the time t4 and the time t5, that is, the sub IC drive stop period, is now focused on. In this period, the flow of the sub primary current to the sub primary coil 12 is interrupted in accordance with the disappearance of the secondary current flowing through the secondary coil 13 regardless of the sub IC drive signal, which is different from the sub IC excessive drive period illustrated in FIG. 12.

Thus, in the ignition system according to the fifth embodiment, it is possible to suppress the continuing flow of the sub primary current to the sub primary coil 12 even when the secondary current has disappeared, which is different from the ignition system in the comparative example.

Next, description is further given of the voltage generated between the collector and the emitter of the transistor 141 of the main IC 14 by the flow of the secondary current through the secondary coil 13 while examples of specific numerical values are given.

As illustrated in FIG. 8 described above, when the main primary coil mode is switched to the de-energization mode at the time t2, the magnitude of the secondary current flowing through the secondary coil 13 is, for example, 100 mA. The magnitude of the secondary current slowly decreases from 100 mA after the time t2, and reaches 0 mA after approximately 2 ms from the time t2. Moreover, when the main primary coil mode is switched to the de-energization mode at the time t2, the voltage generated in the secondary coil 13 is, for example, 100 V.

It is assumed that a winding resistance of the secondary coil 13 is 5 kΩ and a turn ratio between the secondary coil 13 and the main primary coil 11 is 100:1.

In the above-mentioned case, the voltage generated in the winding resistance of the secondary coil 13 by the flow of the secondary current through the winding resistance is 500 V. Thus, when the main primary coil mode is switched from the energization mode to the de-energization mode, a total voltage generated in the secondary coil 13 is 1,500 V.

In the above-mentioned case, a voltage of 15 V is generated in the main primary coil 11, and this voltage is also generated between the collector and the emitter of the transistor 141 of the main IC 14. The sub IC drive determination circuit 17 detects the start of the current supply of the secondary current to the secondary coil 13 through the detection by the detection circuit 16 of the voltage generated between the collector and the emitter of the transistor 141 of the main IC 14, that is, the voltage of 15 V. Moreover, the sub IC drive determination circuit 17 detects the end of the current supply of the secondary current to the secondary coil 13 through a state in which the detection circuit 16 does not detect the voltage generated between the collector and the emitter of the transistor 141 of the main IC 14, that is, the voltage of 15 V.

When the sub IC drive determination circuit 17 detects, from the detection result of the detection circuit 16, that the flow of the secondary current through the secondary coil 13 stops, the sub IC drive determination circuit 17 stops the drive of the sub IC 15. That is, when the secondary current flowing through the secondary coil 13 disappears, the sub IC drive determination circuit 17 stops the drive of the sub IC 15 regardless of the sub IC drive signal input from the ECU 3.

As described above, according to the fifth embodiment, in the ignition system, the detection circuit 16 is configured to detect, as the state of the secondary coil 13, the collector voltage of the transistor 141 of the main IC 14, that is, the main IC collector voltage. Moreover, the sub IC drive determination circuit 17 stops the drive of the sub IC 15 based on the main IC collector voltage detected by the detection circuit 16 as the state of the secondary coil 13.

As a result, it is possible to detect, in accordance with the main IC collector voltage, the flow of the secondary current to the secondary coil 13, and when the secondary current flowing through the secondary coil 13 becomes 0, the sub IC 15 can be controlled regardless of the control from the ECU 3 side. Thus, the same effect as that of the first embodiment is provided.

### Sixth Embodiment

In a sixth embodiment of the present invention, description is given of an ignition system including a plurality of the ignition coil devices 1 in one of the first to fifth embodiments. Note that, in the sixth embodiment, the description of the same points as those of the first to fifth embodiments is omitted, and points different from those of the first to fifth embodiments are mainly described.

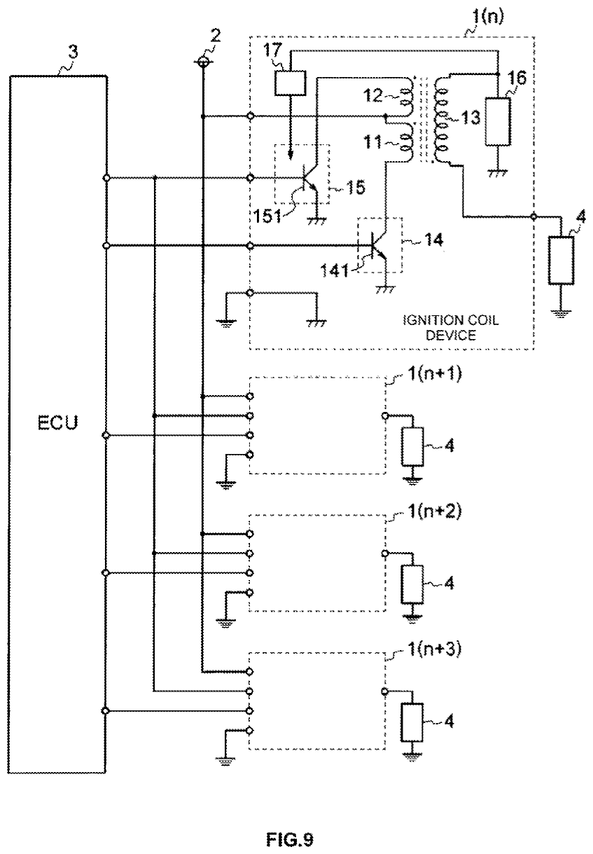

FIG. 9 is a configuration diagram for illustrating the ignition system according to the sixth embodiment of the present invention. The ignition system illustrated in FIG. 9 includes a plurality of ignition coil devices 1, the power supply 2, the ECU 3, and a plurality of ignition plugs 4. Each of the plurality of ignition coil devices 1 include the main primary coil 11, the sub primary coil 12, the secondary coil 13, the main IC 14, the sub IC 15, the detection circuit 16, and the sub IC drive determination circuit 17.

In FIG. 9, for the convenience of description, in order to distinguish the plurality of ignition coil devices 1 from one another, (n), (n+1), (n+2), and (n+3) are added to ends of respective reference numerals “1” of the plurality of ignition coil devices. Moreover, (n), (n+1), (n+2), and (n+3) are added to ends of respective reference numerals of components of the ignition coil devices 1.

In FIG. 9, there is exemplified a case in which the ignition system includes the plurality of ignition coil devices 1 in the first embodiment.

As described above, the number of the ignition coil devices 1 each formed of the main primary coil 11, the sub primary coil 12, the secondary coil 13, the main IC 14, and the sub IC 15 is two or more.

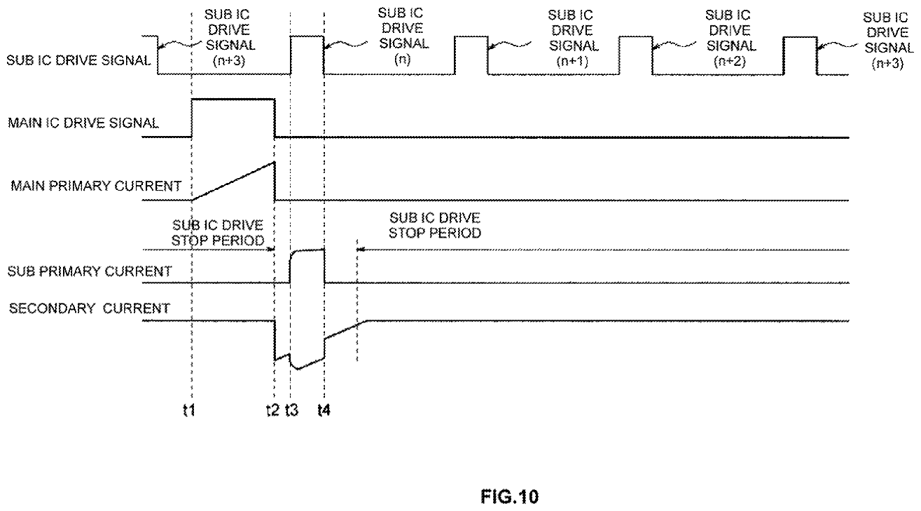

With reference to FIG. 10, description is now given of an operation example of the ignition system according to the sixth embodiment. FIG. 10 is a timing chart for illustrating the operation example of the ignition system according to the sixth embodiment of the present invention. In FIG. 10, as various parameters corresponding to the ignition coil device 1(n), respective temporal changes in the sub IC drive signal, the main IC drive signal (n), the main primary current (n), the sub primary current (n), and the secondary current (n) are illustrated.

The operations of the respective ignition coil devices 1(n) to 1(n+3) are the same, and hence description is now given of the operation of the ignition coil device 1(n) as a representative.

The sub IC drive signal is a signal formed by superimposing a sub IC drive signal (n), a sub IC drive signal (n+1), a sub IC drive signal (n+2), and a sub IC drive signal (n+3) on one another. This signal is hereinafter referred to as “superimposed sub IC drive signal.” The sub IC drive signals (n) to (n30 3) included in the superimposed sub IC drive signal are signals for driving the sub ICs 15(n) to 15(n+3), respectively.

A main IC drive signal (n) is a signal for driving a main IC 14(n). When the main IC drive signal (n) is input from the ECU 3 to the main IC 14(n), the main primary coil mode is switched from the de-energization mode to the energization mode by the drive of the main IC 14(n).

A main primary current (n) is a current flowing through the main primary coil 11(n). A sub primary current (n) is a current flowing through the sub primary coil 12(n). A secondary current (n) is a current flowing through the secondary coil 13(n).

As illustrated in FIG. 10, when the input of the main IC drive signal (n) is started from the ECU 3 to the main IC 14(n) at the time t1, the drive of the main IC 14(n) is started. In this case, the main primary coil mode is switched to the energization mode, and the main primary current (n) in the positive direction flows through the main primary coil 11(n).

At the time t2, when the input of the main IC drive signal (n) from the ECU 3 to the main IC 14(n) is stopped, the drive of the main IC 14(n) is stopped. In this case, the main primary coil mode is switched to the de-energization mode, and the main primary current (n) becomes 0.

At the time t3, when the input of the sub IC drive signal (n) from the ECU 3 to the sub IC 15(n) is started, the drive of the sub IC 15(n) is started. In this case, similarly to the operation illustrated in FIG. 2, the sub primary coil mode is switched to the energization mode, and the sub primary current (n) thus flows through the sub primary coil 12(n). An operation of the ignition coil device 1(n) after the time t4 is as described in each of the first to fifth embodiments.

As described in the first to fifth embodiments, the ignition coil device 1(n) includes the detection circuit 16(n), and thus has the function of detecting the secondary current (n) flowing through the secondary coil 13.

Therefore, in the sixth embodiment, as illustrated in FIG. 10, the ignition coil device 1(n) is configured to use this function so that the sub IC 15(n) is driven in response to only the sub IC drive signal (n) included in the superimposed sub IC drive signal input from the ECU 3 during a period in which the secondary current (n) is supplied to the secondary coil 13(n).

Meanwhile, the ignition coil device 1(n) is configured such that the sub IC 15(n) does not respond to the remaining signals, that is, the sub IC drive signals (n+1), (n+2), and (n+3), which are included in the superimposed sub IC drive signal input from the ECU 3 during a period in which the secondary current (n) is not supplied to the secondary coil 13(n).

As described above, the superimposed sub IC drive signal formed by superimposing the sub IC drive signals (n) to (n+3) corresponding to the respective sub ICs 15(n) to 15(n+3) on one another is input to the respective sub ICs 15(n) to 15(n+3) of the plurality of ignition coil devices 1(n) to 1(n+3). Moreover, each of the sub ICs 15(n) to 15(n+3) is configured to be driven in response to only the sub IC drive signal that is included in the superimposed sub IC drive signal input to this sub IC and that corresponds to this sub IC.

With the configuration of the ignition system according to the sixth embodiment, the sub IC drive signals input from the ECU 3 to the respective ignition coil devices 1(n) to 1(n+3) can be unified as the common superimposed sub IC drive signal. As a result, it is possible to reduce the number of signal lines for outputting the signals from the ECU 3 to the ignition coil devices 1(n) to 1(n+3) corresponding to respective cylinders of the internal combustion engine, which contributes to downsizing and cost reduction of the ignition system.

As described above, according to the sixth embodiment, the superimposed sub IC drive signal formed by superimposing the sub IC drive signals corresponding to the respective sub ICs 15 on one another is input to the sub IC 15 of each of the plurality of ignition coil devices 1 in one of the first to fifth embodiments. Moreover, each of the sub ICs 15 is configured to be driven in response to only the sub IC drive signal that is included in the superimposed sub IC drive signal input to this sub IC and that corresponds to this sub IC.

As a result, through the detection of the current supply of the secondary current to the secondary coil 13 to control each sub IC 15, even when the signal formed by superimposing the sub IC drive signals corresponding to all of the cylinders of the internal combustion engine on one another is input to each sub IC 15, each ignition coil device 1 can drive the sub IC 15 only during the period in which the secondary current is supplied to the own secondary coil 13. Thus, the number of wire harnesses and the number of connector pins of the ECU 3 can be reduced. Those reductions consequently contribute to the downsizing and weight reduction of the ignition system, and further contribute to the cost reduction of the ignition system.

### REFERENCE SIGNS LIST

1, 1A ignition coil device, 2 power supply, 3 ECU, 4 ignition plug, 11 main primary coil, 12 sub primary coil, 13 secondary coil, 14 main IC, 15 sub IC, 16 detection circuit, 17 sub IC drive determination circuit, 141 transistor, 151 transistor, 152 capacitor, 161 resistor, 162 Zener diode

1. An ignition system, comprising:
a main primary coil configured to generate an energization magnetic flux through current supply, and to generate a de-energization magnetic flux in an opposite direction to a direction of the energization magnetic flux through interruption of the current supply;
a main IC configured to switch a main primary coil mode which is a mode of the main primary coil between an energization mode for supplying a current to the main primary coil and a de-energization mode for interrupting the supply of the current to the main primary coil;
a sub primary coil configured to generate an additional magnetic flux in the same direction as the direction of the de-energization magnetic flux through current supply;
a sub IC configured to switch a sub primary coil mode which is a mode of the sub primary coil between an energization mode for supplying a current to the sub primary coil and a de-energization mode for interrupting the supply of the current to the sub primary coil;
a secondary coil configured to magnetically couple to the main primary coil and the sub primary coil, to thereby generate energy;
a control unit configured to: drive the main IC to switch the main primary coil mode from the de-energization mode to the energization mode; stop the drive of the main IC to switch the main primary coil mode from the energization mode to the de-energization mode; drive the sub IC to switch the sub primary coil mode from the de-energization mode to the energization mode; and stop the drive of the sub IC to switch the sub primary coil mode from the energization mode to the de-energization mode; and
a detection circuit configured to detect a state of the secondary coil,
wherein the drive of the sub IC is stopped when the state of the secondary coil detected by the detection circuit is a no-current supply state.

2. The ignition system according to claim 1, further comprising a sub IC drive determination circuit,
wherein the detection circuit is configured to detect a secondary current flowing through the secondary coil as the state of the secondary coil, and
wherein the sub IC drive determination circuit is configured to stop the drive of the sub IC based on the secondary current detected by the detection circuit as the state of the secondary coil.

3. The ignition system according to claim 1, wherein the detection circuit is configured to generate a voltage in accordance with the flow of the secondary current through the secondary coil as the state of the secondary coil, and to supply the generated voltage to the sub IC as a sub IC power supply voltage for driving the sub IC.

4. The ignition system according to claim 3, wherein the detection circuit is formed of a resistor.

5. The ignition system according to claim 4, wherein a resistance value of the resistor is equal to or higher than 100 Ω and equal to or lower than 400 Ω.

6. The ignition system according to claim 3, wherein the detection circuit is formed of a Zener diode.

7. The ignition system according to claim 6, wherein a Zener voltage of the Zener diode is equal to or higher than 5 V and equal to or lower than 20 V.

8. The ignition system according to claim 1, further comprising a sub IC drive determination circuit,
wherein the main IC includes a transistor,
wherein the detection circuit is configured to detect, as the state of the secondary coil, a main IC collector voltage which is a collector voltage of the transistor of the main IC, and
wherein the sub IC drive determination circuit is configured to stop the drive of the sub IC based on the main IC collector voltage detected by the detection circuit as the state of the secondary coil.

9. The ignition system according to any one of claim 1, wherein the sub IC includes a capacitor configured to suppress a surge voltage entering the sub IC as a result of the flow of the secondary current through the secondary coil when the main primary coil mode is switched from the energization mode to the de-energization mode.

10. The ignition system according to claim 9, wherein a capacitance of the capacitor is equal to or smaller than 0.72 μF.

11. The ignition system according to any one of claim 1,
wherein the main primary coil, the sub primary coil, the secondary coil, the main IC, and the sub IC form an ignition coil device,
wherein the number of ignition coil devices is two or more,
wherein a superimposed sub IC drive signal is input to the sub IC of each of the plurality of ignition coil devices, the superimposed sub IC drive signal being formed by superimposing the sub IC drive signals each corresponding to each sub IC on one another, and
wherein each sub IC is configured to be driven in response to only the sub IC drive signal that is included in the superimposed sub IC drive signal input to the each sub IC and that corresponds to the each sub IC.
